(19) United States
(12) Patent Application Publication
(10) Pub. No.: US 2020/0352342 A1
(43) Pub. Date: Nov. 12, 2020

(54) BEDFRAME

(71) Applicant: Dongguan Master Kids Toy Co., Ltd., Dongguan City (CN)

(72) Inventor: Jiahong Xu, Dongguan City (CN)

(73) Assignee: Dongguan Master Kids Toy Co., Ltd.

(21) Appl. No.: 16/408,479

(22) Filed: May 10, 2019

(51) Int. Cl. A47C 19/02; A47C 19/12; F16B 12/56

(52) U.S. Cl. CPC A47C 19/02; F16B 12/56; A47C 19/128

(57) ABSTRACT

A bedframe, comprising an enclosing frame and several support legs installed on the underside of enclosing frame for supporting the enclosing frame and enclosing sheets located between the support legs; an outer opening groove extended in the length direction is located inward in the lateral surface of support leg; the opening width of the outer opening groove is larger than or equal to the inner width of outer opening groove. The enclosing sheet extends out of the support leg along the opening of outer opening groove. In the assembling of enclosing sheet, the first inner tube and the side edge of enclosing sheet are flat put in the opening of outer opening groove along the side edge of support leg, the operation is easy, convenient for later disassembly and cleaning.

### BACKGROUND OF INVENTION

### 1. Field of the Invention

The present invention relates generally to a bedframe of furniture.

### 2. Description of Related Art

The conventional bedframe generally comprises an enclosing frame composed of several crossbeams and joints and several support legs installed on the underside of the enclosing frame and fixed to joints and enclosing sheets provided between the support legs. The most conventional assembly method for the enclosing sheet and support legs: the side edge and upper edge of the enclosing sheet are provided with a first sleeve and a second sleeve. The first sleeve is fitted over the support leg, the first sleeve is fitted over the enclosing frame. To be more specific, when the enclosing sheet is fabric, a first fabric sleeve and a second fabric sleeve are sewn on the side edge and upper edge of fabric respectively. At the beginning of assembling, one end of support leg penetrates one end of the first fabric sleeve and passes through the first fabric sleeve, and one end of crossbeam penetrates one end of the second fabric sleeve and passes through the second fabric sleeve. The penetration of the support leg into the first fabric sleeve and the penetration of crossbeam into the second fabric sleeve are complicated, the operation is inconvenient. Finally, the support legs and crossbeams are assembled by joints to form a complete bedframe. As the side edge and upper edge of fabric cover the support leg and enclosing frame respectively, the whole assembled bedframe is covered with fabric, in other words, the bedframe only appears in fabric, the overall aesthetics of bedframe will not be influenced, accompanied by inconvenient assembly and disassembly and wash, that is a big trouble to the users.

### SUMMARY OF THE INVENTION

The purpose of the present invention is to overcome the deficiencies in the existing technology to provide a bedframe.

In order to solve the above problems, the technical scheme of the present invention is described below:

A bedframe, comprising:

an enclosing frame and a plurality of support legs mounted on an underside of the enclosing frame for supporting the enclosing frame and enclosing sheets between the support legs,

wherein the support leg includes an outer opening groove extending along the longitudinal direction thereof and located inward in a lateral surface, an opening width of the outer opening groove is larger than or equal to an inner width of outer opening groove; a side edge of the enclosing sheet is fixed to a first inner tube, and upper and lower ends of the first inner tube extend out of the upper and lower ends of the enclosing sheet; the first inner tube is mounted straight along the outer opening groove in the lateral surface of the support leg, and an upper end of the support leg is sleeved with a first retaining collar, and the first retaining collar further covers the upper end of the first inner tube; a lower end of the support leg is sleeved with a foot pad, and the foot pad further covers the lower end of the first inner tube; the enclosing sheet extends out of the support leg along the opening of outer opening groove.

More particularly, wherein a diameter of the first inner tube is smaller than or equal to the width of outer opening groove.

More particularly, wherein the enclosing frame includes a plurality of support crossbeams, joints connected between adjacent support crossbeams, a connecting rod which is located at the lower end of the joint and is foldable relative to the joint, the connecting rod is inserted in the upper end of the support leg.

More particularly, wherein the upper end surface of the support leg is downwardly provided with an insertion slot extending through the outer opening groove, a lower end of the connecting rod is inserted into the insertion slot and is screwed by the first retaining collar.

More particularly, wherein the lower end of the connecting rod includes a retaining groove disposed on an outer side thereof, and the upper end of the first inner tube is disposed in the retaining groove.

More particularly, wherein the joint includes a locking mechanism for locking the connecting rod; the locking mechanism includes a slider mounted in the joint by a return spring and slidable up and down, a button mounted on the outside of the joint for driving the slider to slide up and down, a pin mounted in the connecting rod and slidable up and down, a linkage connected between the slider and the pin, an arcuate track groove mounted in the joint, and a locking groove at an end of the arcuate track groove; when the pin falls into the locking groove, the connecting rod is fixedly connected with the joint; when the pin falls into the arcuate track groove, the connecting rod is foldable relative to the joint.

More particularly, wherein the upper end edge of the enclosing sheet is fixed to the second inner tube, both sides of the second inner tube extend out of two sides of the enclosing sheet; the lower end face of the support crossbeam includes a C-shaped slot penetrating two end faces in the length direction, the end of the second inner tube is inserted in the C-shaped slot along one end of the C-shaped slot, and the enclosing sheet extends out of lower end face of support crossbeam along the opening of the C-shaped slot.

More particularly, wherein the opening width of the C-shaped slot is smaller than the inner width of C-shaped slot, and the diameter of the second inner tube is larger than the opening width of C-shaped slot.

More particularly, wherein the outer side of the foot pad is formed with a hook, and the hook has an end portion facing downward to hook the lower side edge of the enclosing sheet; the inner side of the joint is provided with a detachable press fastener, the press fastener and joint hold down the upper end edge of enclosing sheet.

In comparison to prior art, the present invention has the following benefits:

An outer opening groove extended in the length direction is located inward in the lateral surface of support leg of the present invention. In the assembling of enclosing sheet, the side edge of enclosing sheet is fixed to the first inner tube, and the first inner tube and the side edge of enclosing sheet are flat put in the opening of the outer opening groove in the side edge of support leg, instead of this assembly method: it is unnecessary to insert the first inner tube in the outer opening groove from top to bottom, so that the first inner tube can be assembled or disassembled in relation to the support leg quickly, the operation is simple, convenient for later disassembly and cleaning. The enclosing sheet extends out of the support leg along the opening of the outer opening groove; and then a first retaining collar is fitted over the upper end of the support leg, the first retaining collar covers the upper end of the first inner tube. Finally, a foot pad is fitted over the lower end of the support leg, and the foot pad covers the lower end of the first inner tube, so that the first inner tube and the enclosing sheet are fixed to the side edge of support leg, the installation is easy, and the structure is firm, convenient for assembly and disassembly and wash of enclosing sheet. In addition, as the enclosing sheet does not cover the support leg, the support leg is exposed, the overall aesthetics of bedframe is enhanced, and the wood support leg further improves the overall aesthetics of bedframe, giving the present invention very strong marketability.

### BRIEF DESCRIPTION OF THE DRAWINGS

FIG. 1 is a stereogram of the present invention;

FIG. 2 is a partial stereogram of the present invention;

FIG. 3 is a three-dimensional exploded diagram of FIG. 2;

FIG. 4 is an assembly drawing 1 of the support leg and the first inner tube, enclosing sheet and connecting rod in the present invention;

FIG. 5 is an assembly drawing 2 of the support leg and the first inner tube, enclosing sheet and connecting rod in the present invention;

FIG. 6 is a stereogram of support leg in the present invention;

FIG. 7 is a stereogram from another view angle of support leg in the present invention;

FIG. 8 is a stereogram of press fastener in the present invention;

FIG. 9 is an assembly drawing of the support crossbeam and the second inner tube in the present invention;

FIG. 10 is an assembly drawing after folding of the present invention.

### DETAILED DESCRIPTION OF THE INVENTION

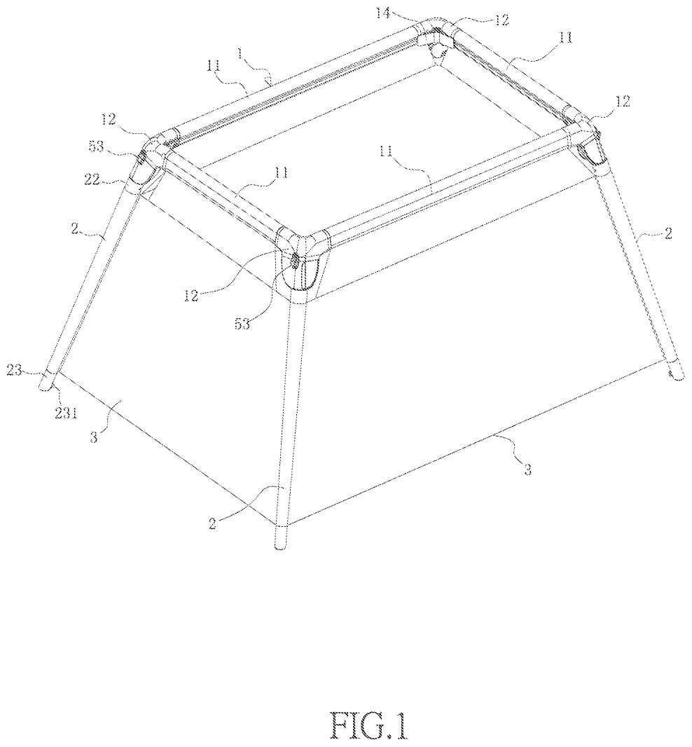

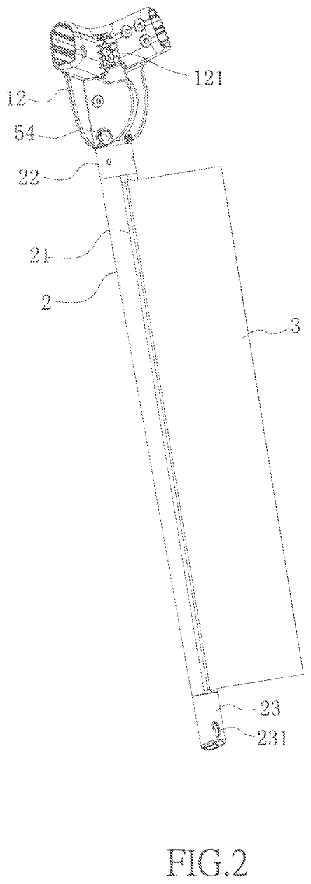

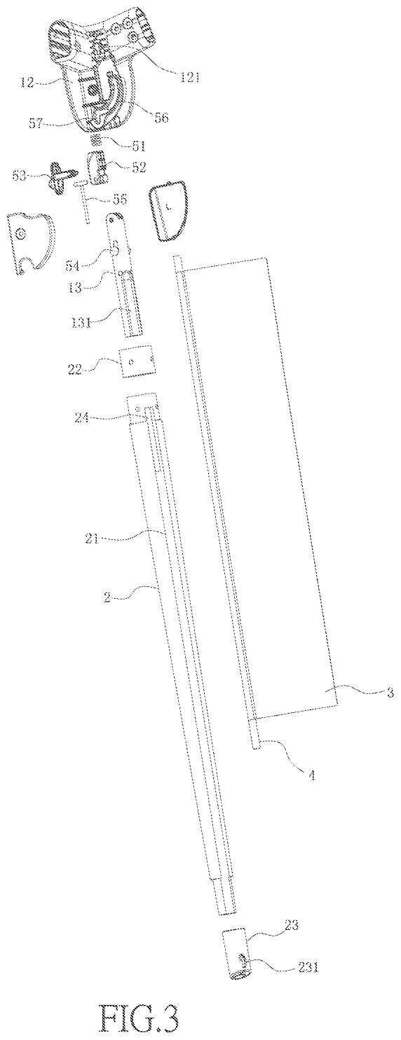

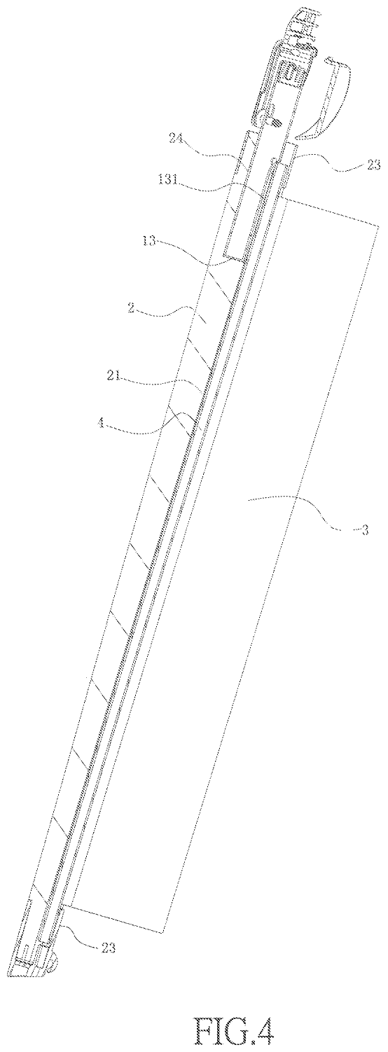

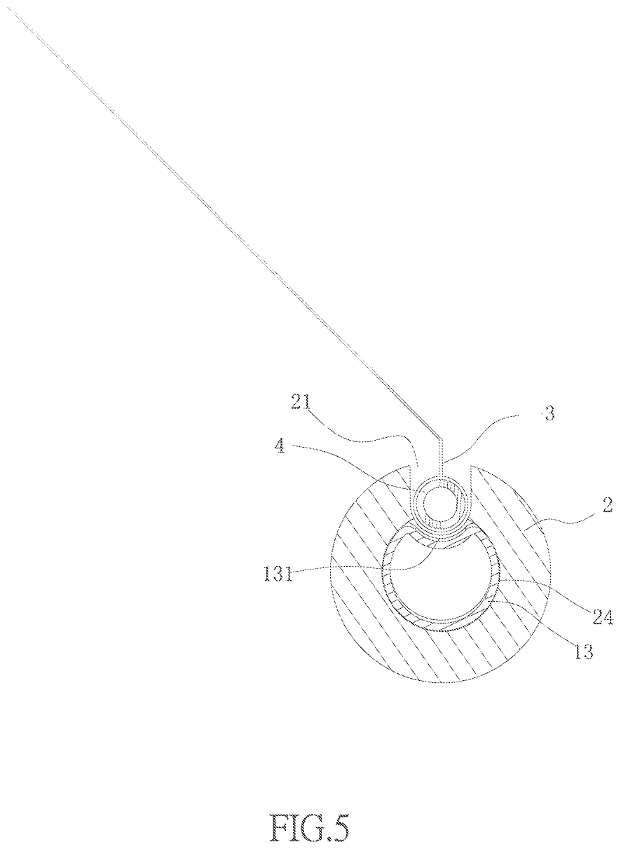

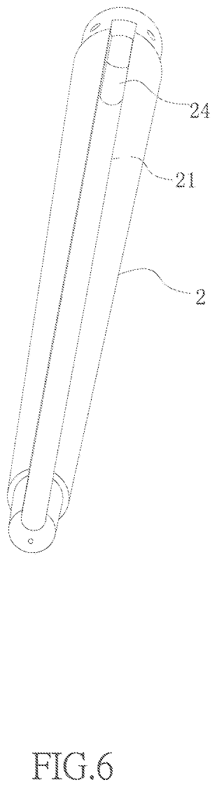

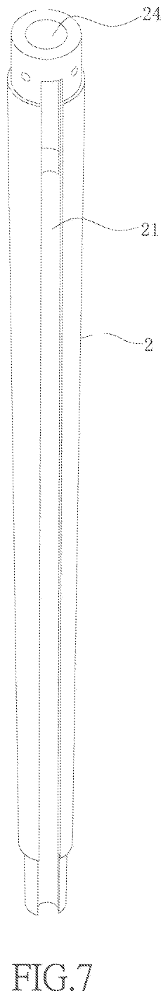

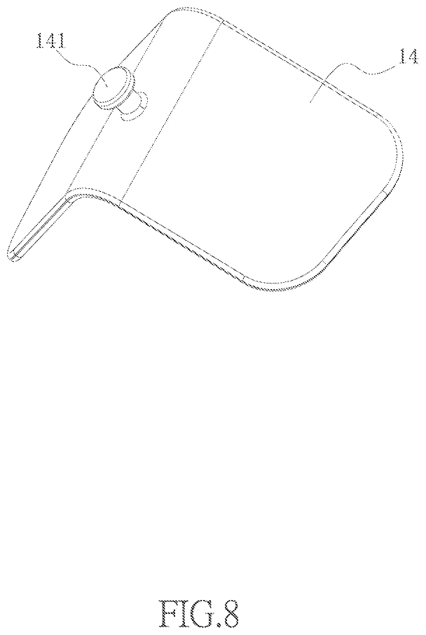

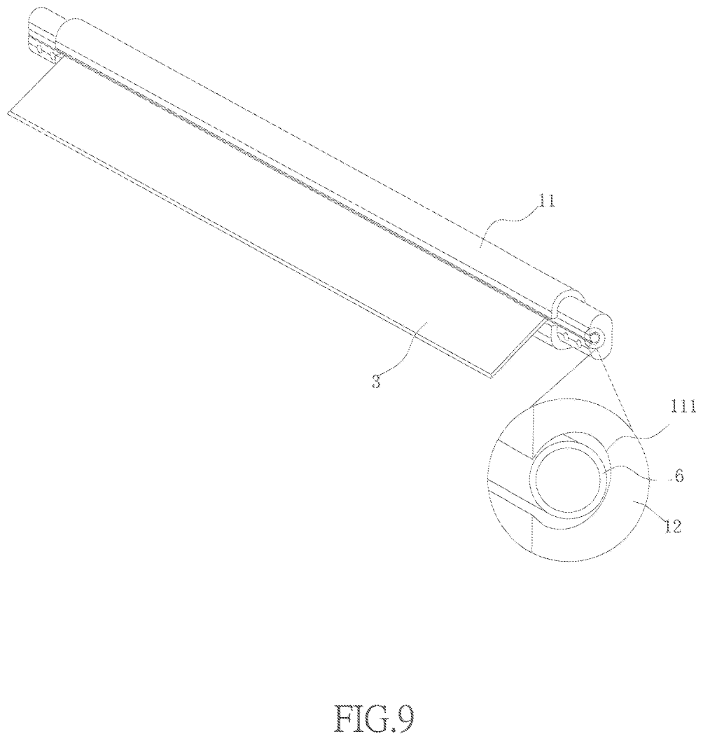

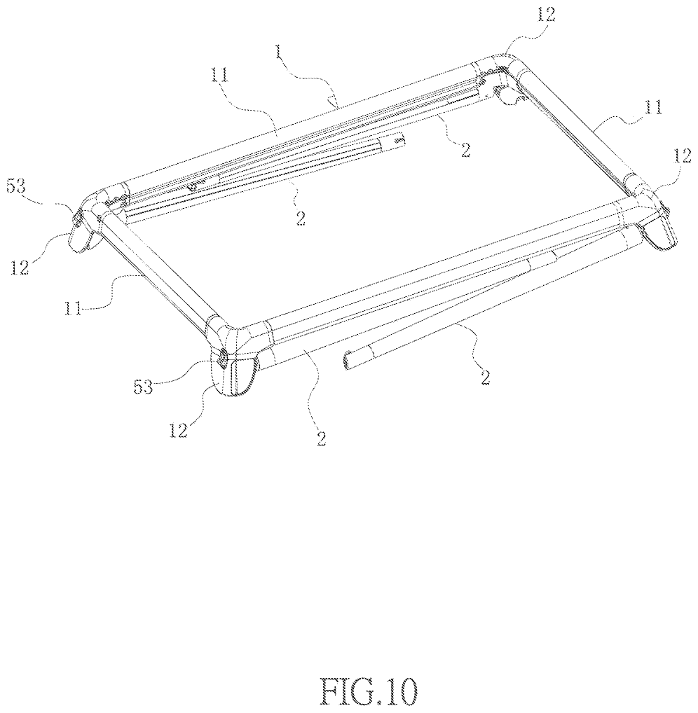

As shown in FIGS. 1-10, a bedframe comprises an enclosing frame 1 and several support legs 2 installed on the underside of the enclosing frame 1 for supporting the enclosing frame 1 and enclosing sheets 3 between the support legs 2. An outer opening groove 21 extended in the length direction is located inward in the lateral surface of the support leg 2; the opening width of the outer opening groove 21 is larger than or equal to the inner width of outer opening groove 21; the side edge of the enclosing sheet 3 is fixed to the first inner tube 4, and the upper and lower ends of the first inner tube 4 extend out of the upper and lower ends of the enclosing sheet 3; the first inner tube 4 is flat inserted in the outer opening groove 21 in the lateral surface of the support leg 2, and a first retaining collar 22 is fitted over the upper end of the support leg 2, the first retaining collar 22 covers the upper end of the first inner tube 4. A foot pad 23 is fitted over the lower end of the support leg 2, and the foot pad 23 covers the lower end of the first inner tube 4. The enclosing sheet 3 extends out of the support leg 2 along the opening of the outer opening groove 21. An outer opening groove 21 extended in the length direction is located inward in the lateral surface of the support leg 2. In the assembling of enclosing sheet 3, the side edge of enclosing sheet 3 is fixed to the first inner tube 4, and the first inner tube 4 and the side edge of enclosing sheet 3 are straightly put in the opening of outer opening groove 21 in the side edge of support leg 2, instead of this assembly method: it is unnecessary to insert the first inner tube 4 in the outer opening groove 21 from top to bottom, so that the first inner tube 4 can be assembled or disassembled quickly in relation to support leg 2, the operation is easy, convenient for later disassembly and cleaning. The enclosing sheet 3 extends out of the support leg 2 along the opening of the outer opening groove 21; and a first retaining collar 22 is fitted over the upper end of the support leg 2, the first retaining collar 22 covers the upper end of the first inner tube 4. Finally, a foot pad 23 is fitted over the lower end of the support leg 2, and the foot pad 23 covers the lower end of the first inner tube 4, so that the first inner tube 4 and enclosing sheet 3 are fixed to the side edge of support leg 2, the installation is easy, the structure is firm, convenient for assembly and disassembly and wash of enclosing sheet. In addition, as the enclosing sheet 3 does not cover the support leg 2, the support leg 2 is exposed, the overall aesthetics of bedframe is enhanced, and the wood support leg 2 further improves the overall aesthetics of bedframe, giving the present invention very strong marketability.

The opening width of the outer opening groove 21 is larger than or equal to the inner width of outer opening groove 21, so that the first inner tube 4 can be flat put in the outer opening groove 21 along the opening of the outer opening groove 21, the assembly and disassembly are convenient. The diameter of the first inner tube 4 is smaller than or equal to the width of outer opening groove 21, so that the first inner tube 4 can be flat put in the outer opening groove 21 along the opening of the outer opening groove 21 more smoothly, the assembly and disassembly are more convenient.

The enclosing sheet 3 can be fabric, it is fixed to the first inner tube 4 by serging.

The enclosing frame 1 comprises several support crossbeams 11 and joints 12 between two adjacent support crossbeams 11. A connecting rod 13 which can be folded against the joint 12 is located at the lower end of the joint 12. The connecting rod 13 is inserted in the upper end of the support leg 2, the support leg 2 can be folded against the enclosing frame 1, so that the present invention is a foldable bedframe, after the support legs 2 are folded against the enclosing frame 1, the volume of the whole bedframe is reduced, it is portable, more convenient to use.

An insertion slot 24 through to the outer opening groove 21 is provided downward in the upper end face of the support leg 2. The lower end of the connecting rod 13 is inserted in the insertion slot 24, and fastened by the first retaining collar 22 and screws, so as to fix the connecting rod 13 to the upper end of the support leg 2.

A retaining groove 131 is located in the outer side of lower end of the connecting rod 13, the upper end of the first inner tube 4 is put in the retaining groove 131, so as to further retain the first inner tube 4, and to further fix the first inner tube 4 to the support leg 2, the structure is firmer.

The joint 12 is provided with a locking mechanism 5 for locking the connecting rod 13. The locking mechanism 5 comprises a slider 52 which can slide up and down installed in the joint 12 by a return spring 51, a button 53 for driving the slider 52 to slide up and down installed on the outer side of the joint 12, a pin 54 which can slide up and down installed in the connecting rod 13, a linkage 55 between the slider 52 and pin 54 and an arcuate track groove 56 installed in the joint 12 and a locking groove 57 connected to the end of the arcuate track groove 56. When the pin 54 falls into the locking groove 57, the connecting rod 13 is fixed to joint 12. When the pin 54 falls into the arcuate track groove 56, the connecting rod 13 can be folded against the joint 12. In normal state, the spring force of the return spring 51 gives the linkage 55 a down force, so that the pin 54 is in the lower stop position. The pin 54 falls into the locking groove 57, the connecting rod 13 is fixed to the joint 12. The support leg 2 cannot be folded against the enclosing frame 1. To fold the support leg 2, the button 53 is pushed up to drive the slider 52 to slide upward, the linkage 55 and pin 54 slide upward accordingly, so that the pin 54 departs from the locking groove 57 to enter the arcuate track groove 56, and then the support leg 2 is folded against the enclosing frame 1, the pin 54 slides in the arcuate track groove 56, so as to fold the support leg 2 against the enclosing frame 1.

The upper end edge of the enclosing sheet 3 is fixed to the second inner tube 6, both sides of the second inner tube 6 extend out of two sides of the enclosing sheet 3; a C-shaped slot 111 penetrating two end faces in the length direction is provided in the lower end face of the support crossbeam 11, the end of the second inner tube 6 is inserted in the C-shaped slot 111 along one end of the C-shaped slot 111, and the enclosing sheet 3 extends out of the lower end face of support crossbeam 11 along the opening of the C-shaped slot 111. As the enclosing sheet 3 has not covered the support crossbeam 11, the whole enclosing frame 1 is exposed, the overall aesthetics of bedframe is enhanced, and the wood support crossbeams further improves the overall aesthetics of bedframe, giving the present invention very strong marketability.

The opening width of the C-shaped slot 111 is smaller than the inner width of C-shaped slot 111, and the diameter of the second inner tube 6 is larger than the opening width of C-shaped slot 111.

A hook 231 is formed on the outer side of the foot pad 23, the end of the hook 231 faces down to hitch the lower side edge of enclosing sheet 3. A detachable press fastener 14 is installed on the inner side of the joint 12, the press fastener 14 and joint 12 hold down the upper end edge of enclosing sheet 3. The upper and lower ends of the enclosing sheet 3 are localized by press fastener 14 and hook 231 respectively, so as to pull the enclosing sheet 3 oppositely to keep the enclosing sheet flat, the overall aesthetics of bedframe is enhanced.

There is an inversely convex locating notch 121 in the inner side of the joint 12, the press fastener 14 is bend angle shaped, a locating tenon 141 with convex section adaptive to the locating notch 121 is formed on the back end, the locating tenon 141 is stuck in the locating notch 121, the press fastener 14 is fixed to the inner side. In order to locate the enclosing sheet better, an interlayer is located in the upper end of enclosing sheet, the press fastener 14 is fixed into the interlayer, and the locating tenon 141 of the press fastener 14 extends out of the enclosing sheet, convenient to be stuck in the locating notch 121.

To sum up, an outer opening groove 21 extended in the length direction is located inward in the outer side of support leg 2 of the present invention. In the assembling of enclosing sheet 3, the side edge of enclosing sheet 3 is fixed to the first inner tube 4, and the first inner tube 4 and the side edge of enclosing sheet 3 are flat put in the opening of outer opening groove 21 in the side edge of support leg 2, instead of this assembly method: it is unnecessary to insert the first inner tube 4 in the outer opening groove 21 from top to bottom, so that the first inner tube 4 can be assembled or disassembled quickly against the support leg 2, the operation is easy, convenient for later disassembly and cleaning. The enclosing sheet 3 extends out of the support leg 2 along the opening of the outer opening groove 21; and then a first retaining collar 22 is fitted over the upper end of the support leg 2, the first retaining collar 22 covers the upper end of the first inner tube 4. Finally, a foot pad 23 is fitted over the lower end of the support leg 2, and the foot pad 23 covers the lower end of the first inner tube 4, so that the first inner tube 4 and the enclosing sheet 3 are firmly installed on the side edge of support leg 2, the installation is easy, and the structure is firm, convenient for assembly and disassembly and wash of enclosing sheet, more convenient to use. In addition, as the enclosing sheet 3 does not cover the support leg 2, the support leg 2 is exposed, the overall aesthetics of bedframe is enhanced, and the wood support legs 2 further improve the overall aesthetics of bedframe, giving the present invention very strong marketability.

I claim:

1. A bedframe, comprising:
an enclosing frame (1) and a plurality of support legs (2) mounted on an lower side of the enclosing frame (1) for supporting the enclosing frame (1) and enclosing sheets (3) between the support legs (2),
wherein the support leg (2) includes an outer opening groove (21) extending along the longitudinal direction thereof and located inward in a lateral surface, an opening width of the outer opening groove (21) is larger than or equal to an inner width of outer opening groove (21); a side edge of the enclosing sheet (3) is fixed to a first inner tube (4), and upper and lower ends of the first inner tube (4) extend out of the upper and lower ends of the enclosing sheet (3); the first inner tube (4) is mounted straight along the outer opening groove (21) in the lateral surface of the support leg (2), and an upper end of the support leg (2) is sleeved with a first retaining collar (22), and the first retaining collar (22) further covers the upper end of the first inner tube (4); a lower end of the support leg (2) is sleeved with a foot pad (23), and the foot pad (23) further covers the lower end of the first inner tube (4); the enclosing sheet (3) extends out of the support leg (2) along the opening of outer opening groove (21).

2. The bedframe defined in claim 1, wherein a diameter of the first inner tube (4) is smaller than or equal to the width of outer opening groove (21).

3. The bedframe defined in claim 1, wherein the enclosing frame (1) includes a plurality of support crossbeams (11), joints (12) connected between adjacent support crossbeams (11), a connecting rod (13) which is located at the lower end of the joint (12) and is foldable relative to the joint (12), the connecting rod (13) is inserted in the upper end of the support leg (2).

4. The bedframe defined in claim 3, wherein the upper end surface of the support leg (2) is downwardly provided with an insertion slot (24) extending through the outer opening groove (21), a lower end of the connecting rod (13) is inserted into the insertion slot (24) and is screwed by the first retaining collar (22).

5. The bedframe defined in claim 4, wherein the lower end of the connecting rod (13) includes a retaining groove (131) disposed on an outer side thereof, and the upper end of the first inner tube (4) is disposed in the retaining groove (131).

6. The bedframe defined in claim 3, wherein the joint (12) includes a locking mechanism (5) for locking the connecting rod (13); the locking mechanism (5) includes a slider (52) mounted in the joint (12) by a return spring (51) and slidable up and down, a button (53) mounted on the outside of the joint (12) for driving the slider (52) to slide up and down, a pin (54) mounted in the connecting rod (13) and slidable up and down, a linkage (55) connected between the slider (52) and the pin (54), an arcuate track groove (56) mounted in the joint (12), and a locking groove (57) at an end of the arcuate track groove (56); when the pin (54) falls into the locking groove (57), the connecting rod (13) is fixedly connected with the joint (12); when the pin (54) falls into the arcuate track groove (56), the connecting rod (13) is foldable relative to the joint (12).

7. The bedframe defined in claim 3, wherein the upper end edge of the enclosing sheet (3) is fixed to the second inner tube (6), both sides of the second inner tube (6) extend out of two sides of the enclosing sheet (3); the lower end face of the support crossbeam (11) includes a C-shaped slot (111) penetrating two end faces in the length direction, the end of the second inner tube (6) is inserted in the C-shaped slot (111) along one end of the C-shaped slot (111), and the enclosing sheet (3) extends out of lower end face of support crossbeam (11) along the opening of the C-shaped slot (11).

8. The bedframe defined in claim 7, wherein the opening width of the C-shaped slot (111) is smaller than the inner width of C-shaped slot (111), and the diameter of the second inner tube (6) is larger than the opening width of C-shaped slot (111).

9. The bedframe defined in claim 3, wherein the outer side of the foot pad (23) is formed with a hook (231), and the hook (231) has an end portion facing downward to hook the lower side edge of the enclosing sheet (3); the inner side of the joint (12) is provided with a detachable press fastener (14), the press fastener (14) and joint (12) hold down the upper end edge of enclosing sheet (3).
